(19) United States
(12) Patent Application Publication
(10) Pub. No.: US 2024/0170637 A1
(43) Pub. Date: May 23, 2024

(54) METHOD AND PROCESS ARRANGEMENT FOR THE PRODUCTION OF AN ELECTRODE FOR A BATTERY CELL

(71) Applicants: Volkswagen Aktiengesellschaft, Wolfsburg (DE); CT Systems GmbH & Co. KG, Wehr (DE)

(72) Inventors: Ludger BUSSWINKEL, Braunschweig (DE); Sven SCHOPF, Braunschweig (DE); Sebastian REUBER, Dresden (DE); Roland SCHMIDT-LOBACH, Hoersingen (DE); Martin SCHLACHTER, Wehr (DE)

(73) Assignees: Volkswagen Aktiengesellschaft, Wolfsburg (DE); CT Systems GmbH & Co. KG, Wehr (DE)

(21) Appl. No.: 18/516,390

(22) Filed: Nov. 21, 2023

(30) Foreign Application Priority Data
Nov. 22, 2022 (DE) 10 2022 130 903.7

(51) Int. Cl. H01M 4/04

(52) U.S. Cl. CPC H01M 4/0435; H01M 4/0404

(57) ABSTRACT

A method for the production of an electrode for a battery cell, with a coating process in which a current collector foil is coated with electrode material by means of a discharge system. The discharge system has a pair of rollers with rotating calender rollers spaced from each other by a roller gap. A powdered output component of the electrode material in the dry state is filled into a roller gap feed section and compacted in the roller gap under pressure and shear to form an electrode material film, which is applied to the current collector foil. The discharge system ensures a temporally and spatially constant and/or adjustable powder dosing into the roller gap.

This nonprovisional application claims priority under 35 U.S.C. § 119(a) to German Patent Application No. 10 2022 130 903.7, which was filed in Germany on Nov. 22, 2022, and which is herein incorporated by reference.

### BACKGROUND OF THE INVENTION

### Field of the Invention

The invention relates to a method for producing an electrode for a battery cell according and a process arrangement for carrying out the method.

### Description of the Background Art

In common practice, an electrode for a lithium-ion battery cell has a current collector foil that is coated with electrode material on one or both sides. The electrode is manufactured in a coating process in which the current collector foil is coated with the electrode material. In a conventional coating process, a wet coating is carried out in which a viscous electrode material mass is applied to the current collector foil by means of a discharge system and then dried in a downstream drying station. Subsequently, the current collector foil coated with the electrical material is compacted in a calender roll mill.

From U.S. Pat. No. 4,436,682 A, a roller compaction is known in which a flowable thermoplastic polymer powder is fed into a roller gap of a pair of rollers of pressure rollers rotating together. The polymer powder is passed through the roller gap under pressure build-up, which forms the polymer powder into a foil-like object. From US 2021 033 6241 A1 a system for the production of an electrode for a battery is known. The system features a mixing unit that produces a powder mixture of active material powder, binder powder and conductive material powder. In addition, the system has a forming unit that forms an electrode film from the powder mixture.

### SUMMARY OF THE INVENTION

It is therefore an object of the invention to provide a method for producing an electrode which, as compared to the conventional art, can be carried out with reduced production costs and process reliability.

In an example, the invention is based on a method for the production of an electrode for a battery cell. The method involves a coating process in which a current collector foil is coated with electrode material by means of a discharge system. The discharge system has a pair of rollers with rotating calender rollers, which are spaced apart by a roller gap. In the dry state, a powdered output component of the electrode material is filled into a feed section of the roller gap and compacted into an electrode material film under pressure and shear. This is guided at the roller gap outlet in the direction of the current collector foil and applied there. According to the characterizing part of claim 1, the discharge system ensures a temporal and spatial, in particular constant powder dosing into the roller gap.

The temporal and spatial, in particular constant powder dosing into the roller gap is achieved by means of a new dosing concept, the characteristics of which are described below: In a technical implementation, the discharge system can have a reservoir from whose outlet opening the powdered output component can be discharged directly into the roller gap feed section under the effect of gravity. Alternatively, the powdered output component can first be discharged from the outlet opening of the reservoir onto a transport chute, along which it is conveyed to a transport chute end, i.e., to a defined discharge edge. From there, the powdered output component can be discharged in a linear manner into the roller gap feed section.

With the help of the discharge system described above, powder discharge to the roller gap feed section can be achieved preferably over a coating width extending in the roller axial direction. The coating width is approximately the same as the width of the transport chute and/or the width of the outlet opening of the reservoir.

In order to ensure that the distribution is as flat and uniform as possible, it is preferable for the outlet opening of the reservoir to be covered with a powder dosing sieve through which the powdered output component in the reservoir is discharged under the effect of gravity. The sieve can be made to vibrate by means of an exciter, such as an ultrasonic or an electrical exciter.

Alternatively and/or in addition to the vibrationally excited sieve described above, the transport chute can also be made to vibrate by means of such an exciter. In this way, a spatially and/or temporally controlled, in particular constant, powder discharge from the reservoir to the roller gap feed section is ensured. In addition, the vibrationally excited transport chute or the vibrationally excited sieve ensures an even, flat distribution of the powdered output component over the entire coating width.

The discharge system can be preceded by a dosing device, in particular a gravimetric weighing unit. With the help of the dosing device, the powdered output component can be fed into the reservoir in a predefined quantity.

The constant and/or adjustable powder dosing into the roller gap according to the invention is of great importance with regard to process reliability. With this in mind, the discharge system can have a control loop with at least one level sensor. The level sensor detects a level of the powdered output component filled into the roller gap feed section. In addition, the control loop has a control unit that controls the discharge system based on the detected fill level in the roller gap feed section in order to control the fill level to a target range. When designing the target range, it should be noted that too high a fill level in the roller gap feed section can lead to pre-compaction of the powdered output component, while too low a fill level can lead to uneven layer formation across the coating width.

In order to control the fill level in the roller gap feed section, the control unit can control the dosing device in particular in order to adjust the amount of powdered component that is fed to the discharge system. Alternatively and/or additionally, the control unit can also be in signal connection with the exciter of the transport chute and/or the exciter of the sieve in order to accelerate or delay the powder flow towards the roller gap feed section.

In order to avoid pre-compaction of the powdered output component, at least one shielding element may be provided in the feed section of the roller gap to shield the powdered output component from the roller surface. In this way, the shielding element forms a sliding zone in which the powdered output component slides along the shielding element and free of contact with the roller surface towards the roller gap without being pre-compacted. Such pre-compaction of the powdered output component in the feed section of the roller gap would adversely lead to an increase in the torques of the roller drive up to a failure of the roller drive, which would severely impair the process reliability of the coating process.

An exciter, in particular an impact and/or vibrating unit, can be assigned to the shielding element. With the help of the impact and/or vibrating unit, the shielding element is set into a vibration movement, which supports the flow of powder along the shielding element towards the roller gap. Alternatively, an exciter can be provided that does not directly cause the shielding element to vibrate, but rather controls an exciter element that can be immersed in the powdered output component filled into the feed section of the roller gap.

With regard to reliable compaction, the powdered output component can be compacted directly in the roller gap. Against this background, the shielding element can extend just to directly in front of the roller gap.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1 to 9 show different variants of the process arrangement according to the invention.

### DETAILED DESCRIPTION

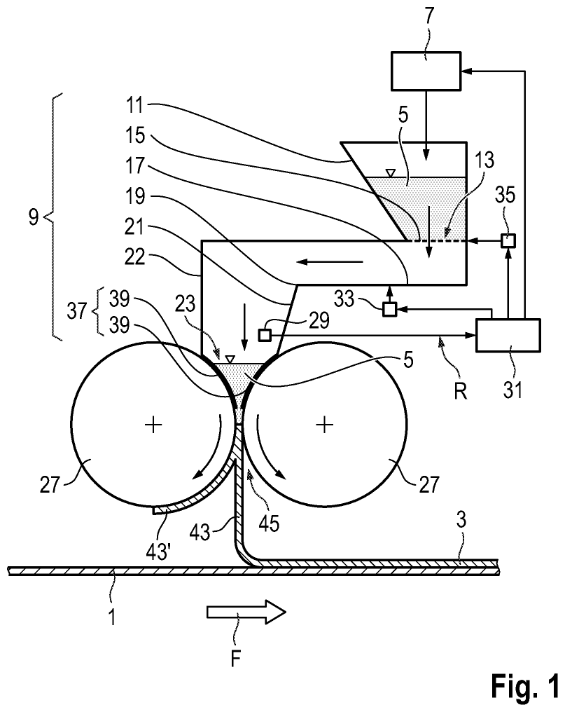

FIG. 1 shows a process arrangement by means of which a coating process for coating a current collector foil 1 with an electrode material 3 can be carried out. The coating process is part of a method for the production of an electrode for a lithium-ion battery cell. According to the invention, a dry coating is carried out in the coating process on the basis of a powdered, flowable output component 5 of the electrode material 3.

According to FIG. 1, the process arrangement has a dosing device 7, for example a gravimetric weighing unit, and a discharge system 9. With the help of the dosing device 7, the powdered output component 5 is fed to a reservoir 11 of the discharge system 9. The reservoir 11 has a slotted outlet opening 13 on the bottom side, which is covered by a sieve 15. During the coating process, the powdered output component 5 is discharged under gravity, distributed over a large area, through the sieve 15 in the outlet opening 13 to a transport chute 17. If necessary, the passage cross-section of the outlet opening 13 can be adjusted by means of a slider. Along the transport chute 17, the powdered output component 5 is conveyed in a horizontal direction to a transport chute end 19 located in a discharge chute 22. The transport chute end 19 is a discharge edge from which the powdered output component 5 is discharged in a linear manner on an inclined plane 21 in a vertical direction into a feed section 23 of a roller gap 25 (FIG. 3), which is formed between two rotating calender rollers 27.

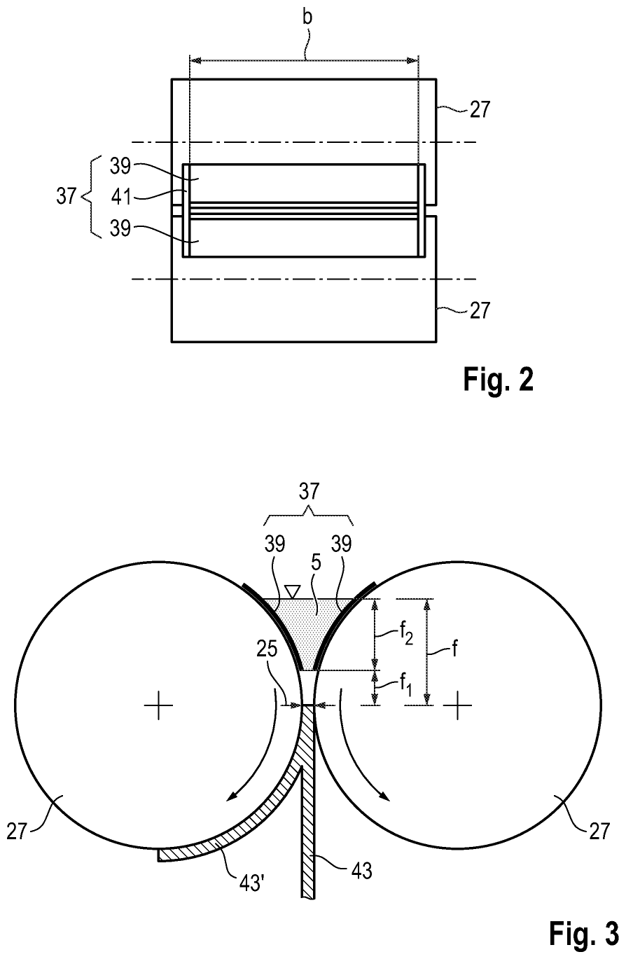

With the help of the discharge system 9, powder is discharged to the roller gap feed section 23 via a coating width b extending in the axial direction of the roller, which is indicated in FIG. 2. FIG. 2 shows the roller gap 25 in a top view. The coating width b corresponds approximately to the width of the transport chute 17 and the width of the outlet opening 13.

The dosing concept according to the invention ensures a temporally and spatially constant powder dosing in which the powdered output component 5 is guided in a spatially and/or temporally uniform constant powder discharge towards the roller gap feed section 23:

For this purpose, the discharge system 9 in FIG. 1 is designed with a control loop R, which has at least one level sensor 29. The level sensor 29 detects a fill level f (FIG. 3) of the powdered output component 5 located in the roller gap feed section 23. In addition, the control loop R has a control unit 31 which, on the basis of the detected fill level f, controls the discharge system 9 and/or the dosing device 7 in order to control the fill level f to a target range.

A core of the invention resides in the fact that the sieve 15 and/or the transport chute 17 are vibrationally excited, i.e., they can be put into vibrations with the help of exciters 33, 35. The exciters 33, 35 are in signal connection with the control unit 31. In addition to a large-area dosing of the powdered output component 5 onto the transport chute 17, the vibrationally excited sieve 15 also ensures spatially and/or temporally controlled, in particular constant powder discharge. The vibrationally excited transport chute 17 acts as a vibrating conveyor, with the help of which a further homogenization of the powder distribution over the coating width b takes place. The horizontal transport along the transport chute 17 and the vertical discharge into the roller gap feed section 23 prevent a change in the surface loading or segregation of the powdered output component 5 along the transport path. If required, the excitation of the sieve 15 and the excitation of the transport chute 17 can be coupled with each other or carried out independently of each other.

As can be seen from FIG. 1, the transport chute 17 merges into the discharge shaft 22, which closes at the bottom in the roller gap feed section 23 with a discharge nozzle 37 that is funnel-shaped in cross-section and slotted in the roller axial direction. In FIG. 1, the discharge nozzle 37 has two shielding elements 39. Each of these shielding elements 39 extends in the roller gap feed section 23 in the contour-adjusted circumferential direction along the respective calender roller 27. The nozzle space bounded between the two shielding elements 39 is bounded on both sides by nozzle walls 41 when viewed in the direction of the roller axial. In the nozzle space of the discharge nozzle 37, the powdered output component 5 collects up to the filling level f. In order to avoid pre-compaction of the powdered output component 5 in the roller gap feed section 23, the two shielding elements 39 shield the powdered output component 5 from the roller surfaces. The shielding elements 39 therefore form a sliding zone in which the powdered output component 5 slides along the two shielding elements 39 and free of contact with the roller surfaces in the direction of the roller gap, thus preventing pre-compaction. Otherwise, such pre-compaction would lead to an increase in the torques of the roller drive and even to the failure of the roller drive. The actual agglomeration or compaction of the powdered output component 5 thus takes place exclusively in the roller gap 25 (FIG. 3).

In FIG. 3, the fill level f is measured from the roller gap 25. According to FIG. 3, the fill level f is divided into a first partial height f₁ and a second partial height f₂ following it upwards. As can be seen from FIG. 3, the two shielding elements 39 are separated from the roller gap 25 via the first partial height f₁, so that the powdered output component 5 is in contact with the roller surfaces of the two calender rollers 27 via the first partial height f₁. On the other hand, the powdered output component 5 is shielded from the roller surfaces by means of the shielding elements 39 via the second partial height f₂ in order to prevent pre-compaction.

In the roller gap 25, the powdered output component 5 is compacted under pressure and shear to form an electrode material film. This is applied to the roller gap outlet side 45 either as a free-standing film 43 on the underlying current collector foil 1. Alternatively, the electrode material film can also adhere to one of the calender rollers 27 as a roller-bearing film 43′ and be applied to the current collector foil 1 in further process steps. In order to increase the processability of the powdered output component 5 in the roller gap 25, the temperature control of the powdered output component 5 can be carried out via the calender rollers 27, for example.

As mentioned above, the transport chute end 19 is a discharge edge by means of which a linear ejection of the powdered output component 5 takes place. Alternatively, instead of such a linear ejection, a two-dimensional ejection can be carried out directly from the vibrationally excited sieve 15. In this case, therefore, there would be no further transport of the powdered output component 5 via the transport chute 17.

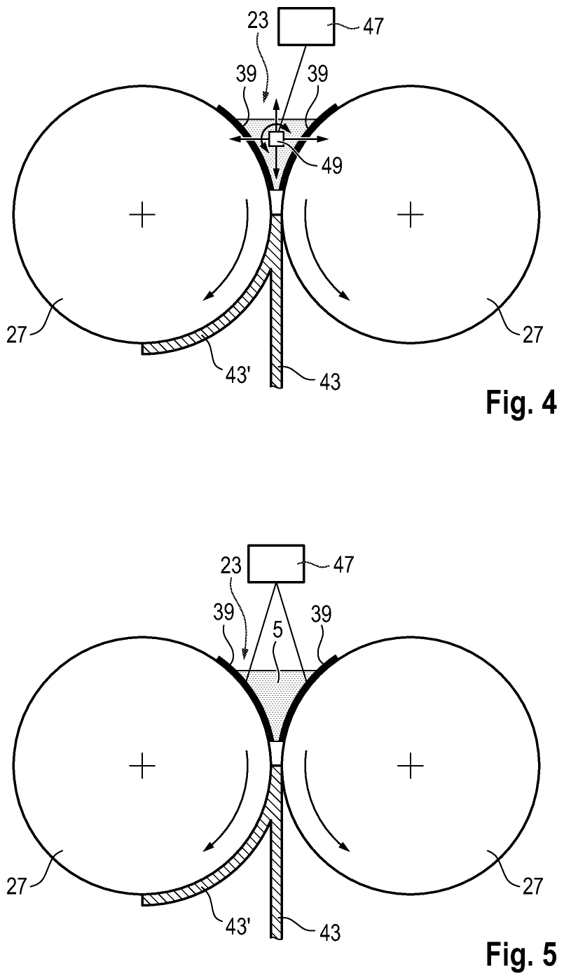

FIGS. 4 to 8 indicate further variants of the invention. In FIG. 4, the exciter 47, such as an ultrasonic or an electrical exciter, is in active connection with an exciter element 49, which is immersed in the powdered output component 5 located in the roller gap feed section 23. In contrast to this, in FIG. 5 the exciter 47 is directly connected with the two shielding elements 39. In this case, the two shielding elements 39 cannot be molded in one piece to the discharge shaft 22 of the discharge system 9, but rather be provided as separate components to enable vibration movement of the shielding elements 39.

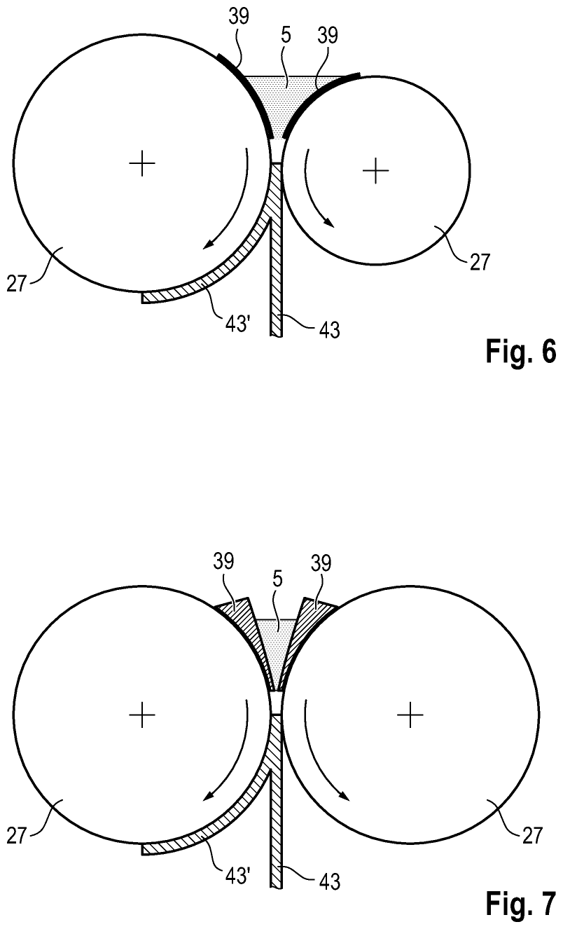

In FIG. 6, the two calender rollers 27 forming the roller gap 25 are not of the same size, but rather of different sizes. Alternatively and/or additionally, the two calender rollers 27 can rotate at different rotation speeds. In FIG. 7, the two shielding elements 39 are not realized as thin-walled components, but rather as wedge-shaped legs made of solid material.

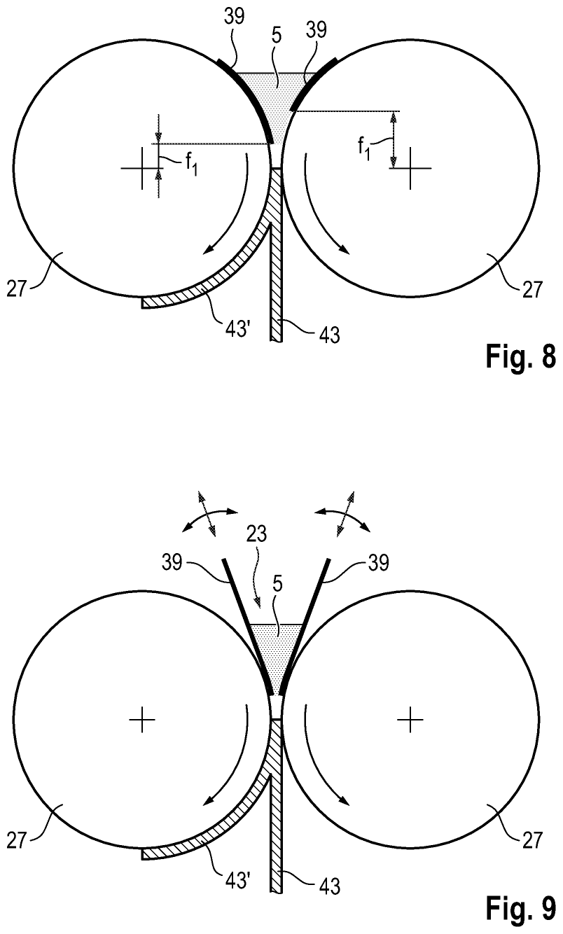

In the preceding figures, the two shielding elements 39 are spaced at equal distances, i.e., over the partial height f₁ (FIG. 1) from the roller gap 25. In contrast to this, in FIG. 8, the two shielding elements 39 are arranged asymmetrically with reference to a central plane, i.e., they are spaced from the roller gap 25 via different partial heights f₁.

In FIG. 9, the two shielding elements 39 are tilt-adjustable by means of an adjustment unit, whereby the passage cross-section of the nozzle space between the two shielding elements 49 can be varied.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for the production of an electrode for a battery cell, the method comprising:
coating, in a coating process, a current collector foil with electrode material via a discharge system, the discharge system comprising a pair of rollers with rotating calender rollers spaced from each other by a roller gap;
filling a powdered output component of the electrode material into a roller gap feed section in a dry state and compacted in the roller gap under pressure and shear to form an electrode material film that is applied to the current collector foil; and
ensuring via the discharge system that a temporally and spatially constant and/or adjustable powder is dosed into the roller gap.

2. The method according to claim 1, wherein the discharge system has a reservoir from whose outlet opening the powdered output component is discharged under effect of gravity directly into the roller gap feed section or is discharged onto a transport chute along which the powdered output component is conveyed in a horizontal direction to a transport chute end from where the powdered output component is discharged vertically into the roller gap feed section and/or an end of the transport chute or a discharge edge at which a linear discharge of the powdered output component takes place.

3. The method according to claim 2, wherein the outlet opening of the reservoir is covered by a sieve for powder dosing, through which the powdered output component located in the reservoir is discharged under the effect of gravity, and/or wherein the sieve is adapted to be put into vibration via an exciter such as an ultrasonic or electrical exciter, and/or wherein the transport chute is adapted to be put into vibration via the exciter to ensure a temporally and spatially constant and/or adjustable powder dosing in the roller gap or to ensure an even distribution of the powdered output component over a coating width.

4. The method according to claim 1, wherein, via the discharge system, a powder discharge is carried out to the roller gap feed section over a coating width extending in the roller axial direction, and/or a width of the transport chute and/or an outlet opening that corresponds to the coating width.

5. The method according to claim 1, wherein the powdered output component is fed to the reservoir via a dosing device or a gravimetric weighing unit.

6. The method according to claim 1, wherein the discharge system is designed with a control loop which has at least one level sensor which detects a fill level of the powdered output component located in the roller gap feed section and/or has a control unit which, on the basis of the detected fill level in the roller gap feed section, controls the discharge system and/or the dosing device which feeds the powdered output component to the reservoir.

7. The method according to claim 6, wherein, for level control in the roller gap feed section, the control unit controls the dosing device in order to adjust the amount of powdered component to be fed to the reservoir and/or wherein the control unit controls the exciter of the sieve and/or the transport chute in order to adjust the powder flow towards the roller gap feed section.

8. A method for producing an electrode for a battery cell, the method comprising:
coating, via a coating process, a current collector foil with electrode material via a discharge system, the discharge system comprising a pair of rollers with rotating calender rollers spaced from each other by a roller gap;
filling a powdered output component of the electrode material in a dry state into a roller gap feed section and compacting it in the roller gap under pressure and shear to form an electrode material film that is applied to the current collector foil; and
providing at least one shielding element to avoid pre-compaction of the powdered output component in the roller gap feed section, the at least one shielding element shields the powdered output component from a roller surface by forming a sliding zone in which the powdered output component slides along the shielding element and free of contact with the roller surface in the direction of the roller gap.

9. The method according to claim 8, wherein an exciter or an impact and/or vibrating unit is assigned to the shielding element, and wherein via the exciter, the shielding element is put into vibration in order to support a powder flow in a direction of the roller gap or that an exciter is provided with which an exciter element is adapted to be controlled, which is immersed in the powdered output component filled into the roller gap feed section and/or wherein the shielding element extends to just in front of the roller gap or is separated from the roller gap by a partial height.

10. A process arrangement to perform the method according to claim 1.
